(19) United States
(12) Patent Application Publication
(10) Pub. No.: US 2023/0325745 A1
(43) Pub. Date: Oct. 12, 2023

(54) SYSTEM FOR AUTOMATED PLANNING AND/OR APPROVAL OF A BUILDING AND METHOD FOR OPERATING THE SYSTEM

(71) Applicant: SWISS PROPERTY AG, Zurich (CH)

(72) Inventors: Markus STEINBRECHER, Zurich (CH); Manuel VOGLER, Zurich (CH); Johannes MAY, Zurich (CH); Ralf STAUB, Zurich (CH)

(21) Appl. No.: 18/041,358

(22) PCT Filed: Aug. 9, 2021
(86) PCT No.: PCT/EP2021/072152

§ 371 Date: Feb. 10, 2023

(30) Foreign Application Priority Data
Aug. 10, 2020 (EP) 20190371.3

(51) Int. Cl. G06Q 10/0631; G06Q 50/08

(52) U.S. Cl. CPC G06Q 10/06316; G06Q 50/08

(57) ABSTRACT

The present invention relates to a system for automated planning and/or approval of at least one building, comprising at least one input module for inputting data concerning the building and/or components of the building, at least one output module for outputting data concerning the building and/or components of the building, a server unit on which data relating to the building and/or the components of the building are held, and a calculation module which is designed in such a way that, by means of the calculation module, planning and/or approval data of the building can be calculated automatically on the basis of data relating to the building and/or the components of the building.

The present invention relates to a system for automated planning and/or approval of a building. It further relates to a method for automated planning and/or approval of a building.

A large number of digital systems are already used in the planning of buildings. These relate in particular to design systems or also simulation systems for energy consumption, but also for people flows through the building (especially in public spaces), on the subject of firefighting or concerning the evacuation of buildings.

In connection with the approval of buildings, increasing attention is now being paid to the energy efficiency of buildings and energy consumption.

It is essential for the approval of buildings to calculate and provide the correspondingly required energy certificates.

Presently, however, this is very time-consuming, as extensive calculations have to be made and then the relevant approval documents have to be compiled manually from these calculations.

EP 2 182 336 A2 describes a method for providing comparative data for evaluating the energy properties and/or energy costs of a building.

DE 10 2017 209 084 A1 discloses a method for improving an energy efficiency of a building under design. The method comprises the following steps: Providing a basic digital model of the building by means of a computing unit, defining a plurality of different function-related room categories by means of the computing unit, assigning existing technical building automation functions stored in a storage unit coupled to the computing unit to the different room categories by means of the computing unit, arranging function-related rooms in the basic digital model of the building by assigning the defined function-related room categories to the basic digital model of the building based on an occupancy plan of the building by means of the computing unit, virtually coupling the function-related rooms with supply lines of a virtual building automation system on the basis of the assigned technical building automation functions by means of the computing unit, determining an energy efficiency of the virtual building on the basis of the function-related rooms coupled with the supply lines by means of the computing unit, and selecting suitable plant engineering modules for the building automation from a list of available plant engineering modules stored in a memory unit on the basis of the determined energy efficiency and the function-related rooms coupled with the supply lines by means of the computing unit. Further, the invention described therein relates to a system for improving an energy efficiency of a building under design.

It is the task of the present invention to further form a system of the type mentioned at the beginning in an advantageous manner, in particular to the effect that approval procedures for buildings can be simplified and made more efficient overall.

According to the invention, this task is solved by a system having the features of claim 1. Accordingly, the system for automated planning and/or approval of at least one building comprises at least one input module for inputting data relating to a building and/or components of a building. It further comprises at least one output module for outputting data relating to the building and/or the components of the building, a server unit on which data relating to the building and/or the components of the building are stored, and a calculation module which is designed in such a way that planning and/or approval data of the building can be automatically calculated by means of the calculation module on the basis of data relating to the building and/or the components of the building.

The invention is based on the basic idea of automating the collection and processing of the data required in the planning and/or approval process to the greatest possible extent and determining the relevant parameters of the building directly. This achieves a particularly efficient mode of operation and avoids the need to enter data several times. It can also be avoided that already existing data has to be manually extracted or otherwise read out again from the plans, e.g. in order to fill in forms in electronic and/or paper form. Furthermore, the planning and/or approval data is provided in such a way that it can be taken into account directly in the planning process and, if possible, made available directly to a relevant authority. In addition, aspects of the building and/or its components that are relevant to planning and/or approval are identified directly and measures can be initiated to deal with potential problems. An automated check of legal regulations, which is based on validated and unchangeably stored rules of the respective parties involved, furthermore enables the increase of the degree of automation and thus also acceleration of calculation steps in the planning and/or approval process, since a sequential referral back or resubmission to the respective parties involved is omitted or avoided.

In particular, the data concerning the building and/or concerning components of the building that is recorded by means of the input module can be input data. Furthermore, the data concerning the building and/or concerning components of the building that can be output by means of the output module can be output data. Furthermore, the data concerning the building and/or concerning components of the building stored on the server unit may be server data.

In one embodiment of the system, the planning and/or approval data is or includes energy verification data of the building. Advantageously, this means that data is available directly (i.e. generated in particular directly from the system and the data records held there) which is particularly relevant for the planning and/or approval procedure. This also contributes to improving the efficiency of the procedure and eliminating the need for multiple data entry or even the reading out of data for the preparation of approval documents.

In particular, the energy certificate data is formed in such a way that it can be used directly in the planning and/or approval process. For this purpose, the data for the energy certificate required by an authority is determined and provided in full.

In another embodiment, the system has an authentication module by means of which the planning and/or approval data can be provided in a completely traceable and tamper-proof manner. Advantageously, this protects the data provided against manipulation. The data is then particularly trustworthy.

Known procedures can be used, in which access - especially write access - is restricted to the data relevant to the planning and/or approval process and/or changes are documented in a traceable and secure manner.

For example, a process from the field of distributed ledger technology (DLT) can be used, such as a blockchain process, to cryptographically secure the integrity of the data and the traceability of previous changes. In addition to Blockchain, alternative or additional DLT procedures include procedures such as IOTA or Hashgraph. Further examples are Ethereum, Hyperledger, Corda, Openchain, BigChainDB etc.

The term distributed ledger technology (DLT) refers to a technique used for documenting certain transactions. In contrast to the classic approach, in which a ledger is generally managed by just one instance, DLT involves different parties maintaining any number of copies of the ledger, which are in principle identical, in a decentralized manner. Appropriate measures are taken to ensure that new transactions are added to all copies of the ledger and that there is consensus on the current status of the ledger.

For example, DLTs differ in the way networked computers come to an agreement (i.e., consensus protocols), such as proof of work as in Bitcoin, proof of economic interest (proof of stake, as in Ethereum’s Casper), a coordinator as in Raft, or elections as in Swirlds.

There are public DLTs (anyone can participate in the network and view the data) and private DLTs (which only allow access and participation to a limited group)

In a further embodiment, the system has an interface to an approval authority, the interface being such that it enables a secure exchange of data relating to the building and/or the components of the building. Advantageously, the planning and/or approval procedure can thus be carried out particularly efficiently by making the relevant data available to the authorities concerned in an efficient, structured and secure manner. The term secure in this context not only includes secure authentication of the authorized user, it can also be ensured overall on the basis of the structure and nature that a tamper-proof connection is provided, in particular in conjunction with DLT. This facilitates legal transactions with the authorities and enables fast and simple processing both on the applicant side and on the authority side.

For example, the interface can be set up to use protocols known per se for secure data communication, in particular for cryptographically securing communication, for example by encrypting and/or signing exchanged data. In particular, this involves end-to-end encryption of data between the system and the approval authority. The secure data exchange takes place in such a way that the transmitted data is protected against reading and/or modification by unauthorized persons, for example to ensure the confidentiality of the communication and/or the integrity of the transmitted data.

A distributed ledger process, in particular a blockchain process, can also be used for the secure exchange of data. In particular, cryptographic processes are also used here to ensure that communication is secure and trustworthy.

Predefined authority interfaces can be used to establish, at least temporarily, a data link between the system’s interface and the authority.

In one embodiment, the system has an energy certificate generation module that is such that it automatically generates an energy certificate for the building based on the data calculated and/or provided by the calculation module. Advantageously, this speeds up the planning and/or approval process.

In particular, the approval process can also be at least partially automated on the authority side and the system can initiate the approval process or provide the relevant data by means of an interface.

In a further embodiment, the system has at least one energy consumption calculation module by means of which the energy consumption of the building can be calculated, in particular taking into account the data relating to the building and/or components of the building. The data thereby advantageously acquired at a particularly early stage are highly relevant for the subsequent planning and/or approval procedure.

In particular, the data used here concerning the building and/or components of the building may be data concerning the building and/or components of the building acquired by the input module, output by the output module and/or held on the server module.

For example, an application concerning energy consumption may be used, such as acquisition, and the application may be integrated into the system or accessed by means of an interface of the system.

In a further embodiment, the system has at least one design module and/or it can be connected to at least one design module. As a result, the data relevant to the planning and/or approval process can advantageously be recorded at a particularly early stage. Furthermore, if necessary, critical parameters can be detected and adjusted at a particularly early stage.

The parameters specified during design play a particularly important role in determining data for the planning and/or approval process. With the framework conditions and parameters specified here, the system can recognize which critical or approval-relevant variables should be adjusted or changed and any necessary changes can be made at an early stage.

In one embodiment, the system has at least one plausibility module that checks the plausibility of the data calculated by the calculation module on the basis of plausibility data stored in the plausibility module. In this way, it is advantageously determined particularly quickly whether the available data are suitable for use in the planning and/or approval procedure.

During the plausibility check, for example, threshold values can be determined for certain parameters that are covered by the data concerning the building and/or components of the building. In the event of a deviation of the parameters beyond the threshold values, a warning can be issued to a user of the system, possible suggestions for changes can be issued, or the planning and/or approval procedure can be interrupted.

In a further development, the plausibility module is designed to be self-learning. This means that the plausibility check can advantageously be designed to be particularly simple and comprehensive.

Various self-learning methods known per se can be applied, for example from the field of artificial intelligence and/or machine learning. For example, neural networks can be used.

In the self-learning procedure, data from completed planning and/or approval procedures can be used in a learning phase.

Furthermore, it can be provided that the system enables an automated check of legal regulations in the context of the approval of a building, in that e.g. the architect and a certain technical expert (e.g. a fire protection expert) can define, validate and store rules within a Digital Building System (DBS) in order to ensure that the results and data used are stored in a comprehensible and unchangeable manner for all parties involved. The validated rules thereby ensure a permissible automation of the calculations, since individual calculations or calculation steps no longer require a resubmission or return to a participant arranged earlier in the calculation process, since this participant has already confirmed its results by means of its validated rules in a secure and unchangeable manner.

Today, the verification of legal requirements is usually done by extracting information from the architectural model of the building by the architect and providing this information to the corresponding technical expert (e.g. fire protection expert). The subject matter expert verifies the correctness of the provided data, taking into account legal requirements. The results of the technical expert are then in turn provided to the architect. Since the results calculated by the subject matter experts usually have legal relevance for the construction of the building (e.g., fire protection evaluation for the building permit), the subject matter experts depend on using correct and comprehensible data in their calculations. Today, this process is mostly done through the exchange of documents and the result (e.g. fire protection concept) is dabb confirmed by the signature of the project participants. However, the information used to create it (architectural models, component structures, etc.) is not stored in a traceable and unchangeable way as part of the result.

Furthermore, a method is provided for operating a system according to the present application for automated and/or partially automated approval and/or partial approval of a building. The method has the same advantages as the system it is arranged to operate.

Furthermore, a use of a system according to the present application for automated and/or partially automated approval and/or partial approval of a building is provided. This use has the same advantages as the system or as the method for operating the system.

Various embodiments of the system and method are described below.

In one embodiment, a central product repository (Adaptable Product System; APS) is provided. This allows information on components of a building to be stored in a central location, particularly in the sense of a “single source of truth” concept (SSOT). This involves linking data from different software solutions by experts in the field, such as an architect or a civil engineer. In particular, it allows the information required in the use cases, such as price or insulation value, to be stored.

-In particular, the introduction of product hierarchies is planned. The APS allows the combination of individual elements through defined hierarchies. For example, individual elements can be combined into modules and modules into products. The structure of the hierarchies is freely definable by the user, see the meta model described below.

The APS also provides a set of rules that enables business rules to be described by mathematical formulas and applied to the elements, modules and products of the product repository. In particular, the set of rules also contains rules that are relevant for defined use cases, such as for an energy certificate or for fire protection regulations.

Furthermore, dynamic data structures are made possible. Elements, modules or products have defined attributes, such as a specific price or insulation value, and relationships. The attributes and relationships can be changed without adapting the software code or the database structure. This means that attributes such as a color can be defined by the user without the involvement of a software developer. For this purpose, APS provides a suitable database structure that allows data objects, attributes and relationships to be controlled by a metamodel. If a new object, attribute or relationship is defined by the user, the software completes the metamodel. Further, especially manual, adjustments to the software code or database structure are not necessary.

It also provides an improved specification and rules for the adaptability of the system. The APS enables the storage of specifications of elements, modules and products, such as general properties of a wall module, and it enables the storage of instances of these specifications, such as the representation of the actually installed wall in a construction project. The specifications also describe rules that define how and under what conditions elements of the product repository can be combined. In particular, these rules also define whether and in what way elements can be modified, such as how the width, height and depth of a wall module can be adjusted by the architect in the CAD software.

Furthermore, standards are better used and improved compatibility of the system is made possible. The data structures of the APS use existing industry standards (e.g. Industry Foundation Classes, IFC), existing specifications, guidelines and laws (e.g. for energy certificates) and supplement and link these data structures to enable the central repository described at the beginning. The metamodel described above makes it possible to adapt these standards without having to adapt the software code.

Aspects of the integration of the system are described below.

The system provides interfaces between a) the software solutions used by the subject matter experts (e.g. Archicad), b) the central repository of the APS and c) a third party system (e.g. authorities). The data exchange takes place either by file export and import, partly manually by the user or automated by bidirectional interfaces.

To enable an “Extract, Transform, Load” (ETL), the system provides appropriate procedures to extract data from a source, translate it, and load it into a target system.

Furthermore, “APS matching” can be performed. For an increase in efficiency of the use cases, the integration enables in particular a suitable recognition of the data from the software solutions of the subject matter experts (e.g. data from the 3D model of the architect) and an assignment to elements, modules and products of the APS. Thus, for example, all elements of the 3D model can be automatically enriched with information on insulation values from the APS.

In the embodiment exemplified, services are further provided by means of artificial intelligence services (AI services) or by means of machine learning.

For example, pattern recognition is used. The system provides suitable methods for recognizing patterns (e.g. room, window) from existing data (e.g. documents such as 2D/3D plans, IFC export, Archicad file). Using the information from the patterns, additional information can be derived, such as a room size or the number of windows). Pattern recognition is based on algorithms and historicized data.

Furthermore, recommendations can also be generated and issued. The system provides suitable procedures that allow predictions to be made on specific issues and recommendations to be formulated with the help of algorithms and historicized data. For example, the system can determine energy consumption, compare it with historicized plans, and identify weak points or alternatives.

In the example, the system is designed to be self-learning, which means that it independently adapts the algorithms and improves them with new information.

The system provides a suitable data store as a data basis for the historicized storage of all data required for the AI services.

In the embodiment exemplified, so-called “distributed ledger technology services” (DLT services) may further be provided.

The system provides suitable procedures for unchangeable storage, which allow a defined selection of information (e.g. official documents such as a building application) to be stored in such a way that it cannot be changed without being noticed and/or without appropriate authorization. In this context, it may further be provided that by means of an authorization, the respective person making the change is identifiable for each change. A DLT process, such as a blockchain process, and/or another cryptographic process can be used for implementation.

The system provides a procedure that allows defined user groups to verify and examine documents for accuracy. For example, the builder can examine whether his local copy of the architectural plan matches the plan stored in the APS (binary verification). Again, a DLT method, such as a blockchain method, and/or another cryptographic method can be used for implementation.

The exemplary embodiment further enables certified products and inspection rules. In this context, the system provides a suitable procedure that allows information of the elements, modules and products defined in the APS to be stored unchangeably. This ensures that an element, module or product, including all relevant information, is uniquely identifiable and that its properties are known. Furthermore, this makes it possible for the result of an inspection of the element, module or product (e.g. from the point of view of fire protection) to be stored unchangeably. The data and rules required for a test are also defined in the system (so-called smart contracts) and can be seen by a defined user group at any time, and their application can be traced; for example, it can be seen which data and rules were used to test a particular energy certificate. Again, a DLT method, such as a blockchain method, and/or another cryptographic method can be used for implementation.

Further details and advantages of the invention will now be described with reference to an example of an embodiment shown in more detail in the drawing.

It shows

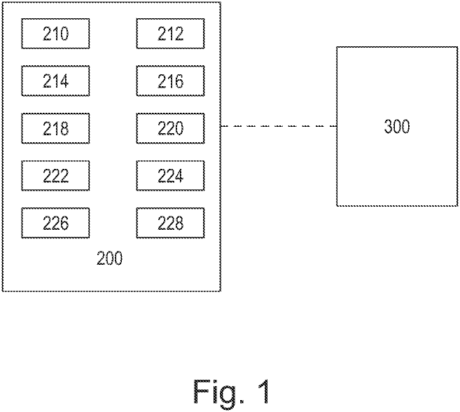

FIG. 1 A first embodiment of the system and the method for its operation;

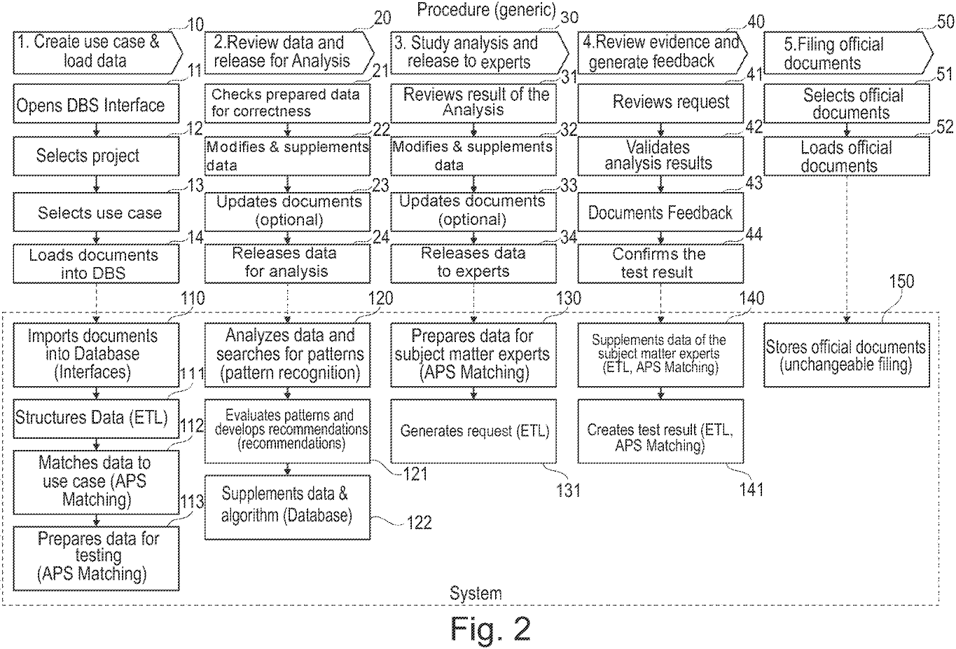

FIG. 2 A further embodiment of the method of operating the system;

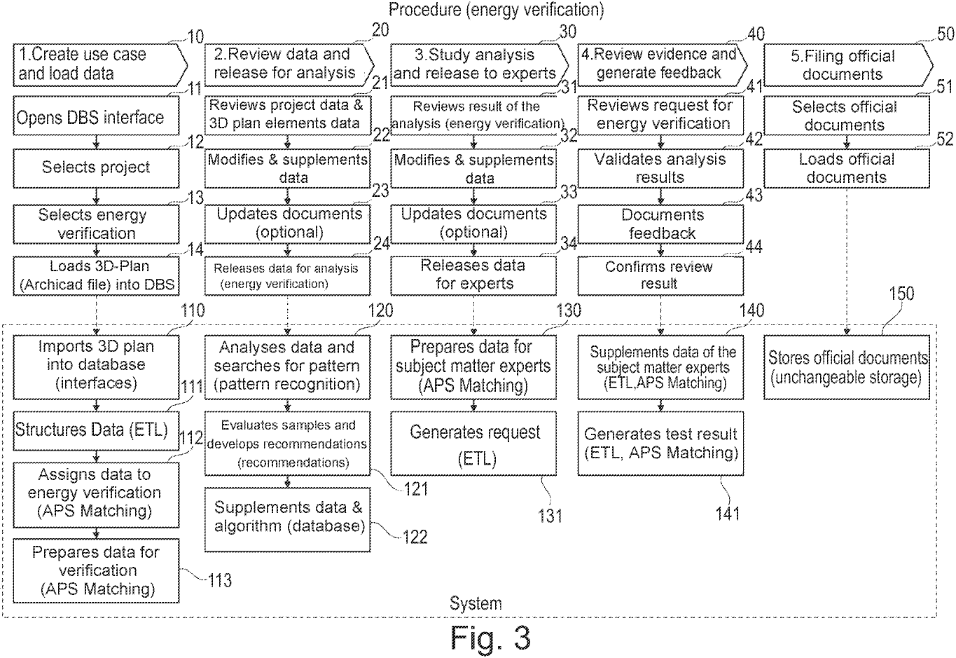

FIG. 3 A further embodiment of the method of operating the system;

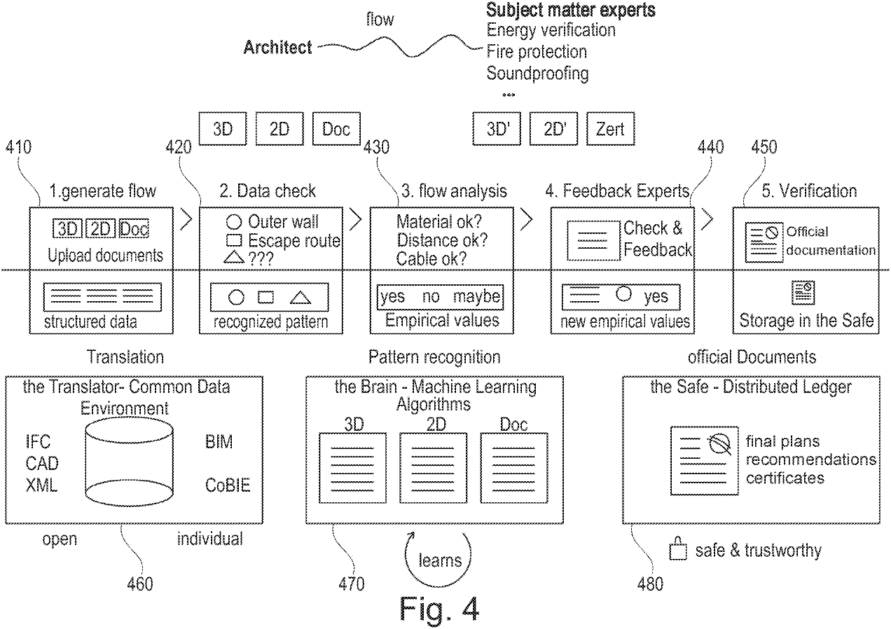

FIG. 4 A further embodiment of the system and the method for its operation;

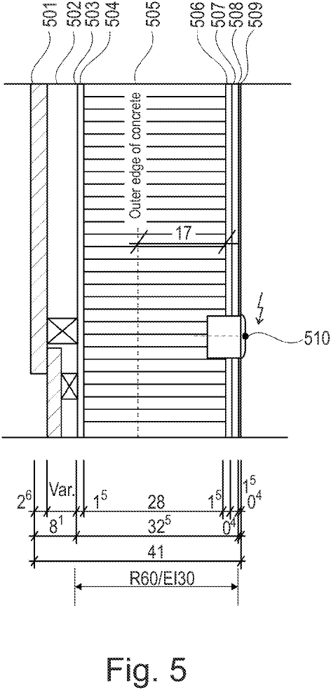

FIG. 5 An embodiment example of a pattern recognition performed by means of the system;

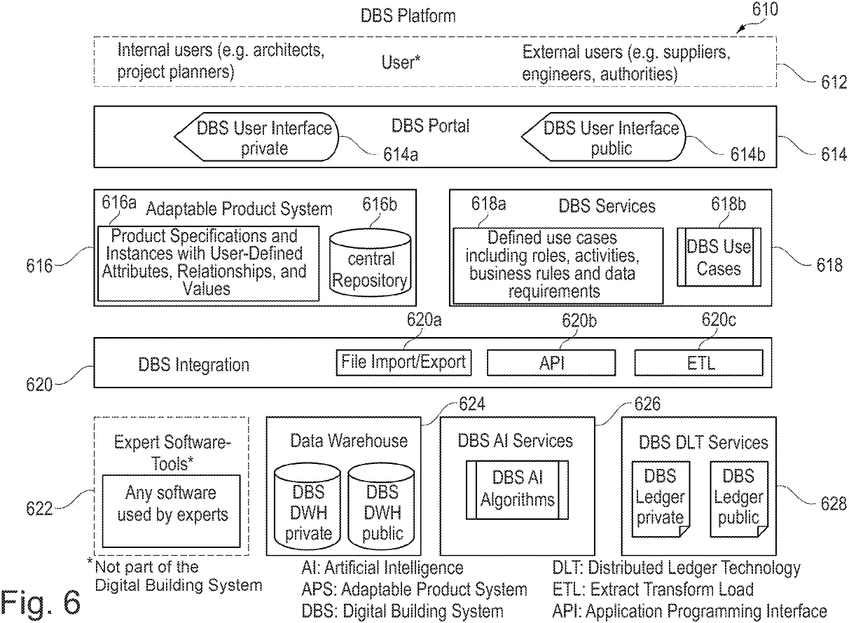

FIG. 6 A further embodiment of the system and the method for its operation;

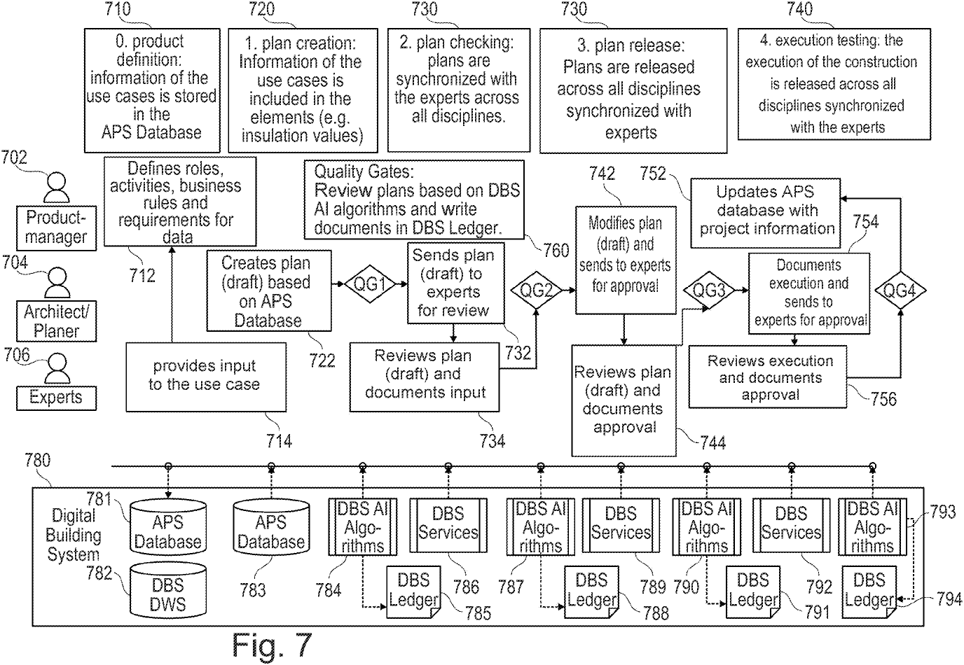

FIG. 7 A further embodiment of the system and the method for its operation;

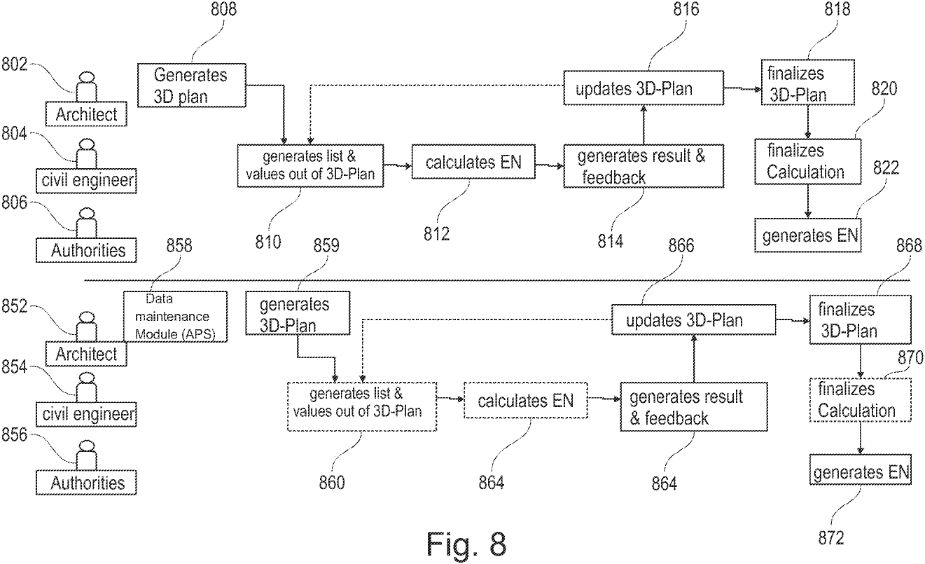

FIG. 8 A further embodiment of the system and the method for its operation;

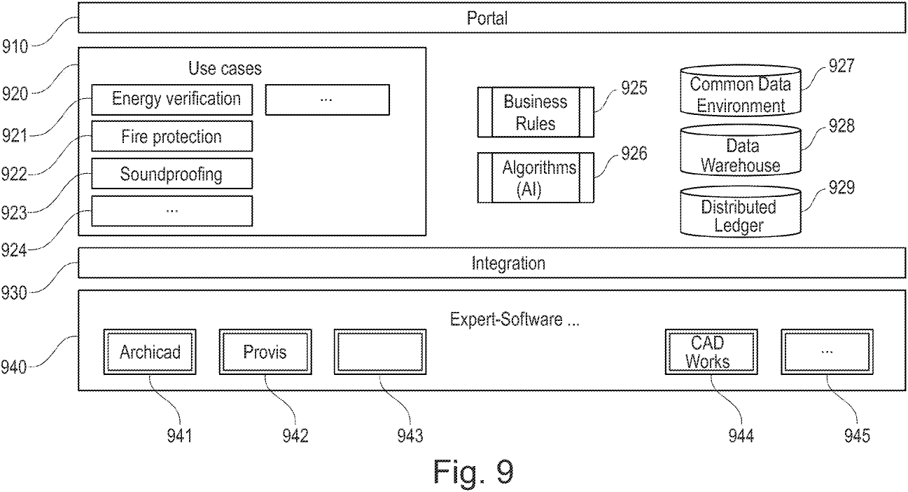

FIG. 9 A further embodiment of the system and the method for its operation;

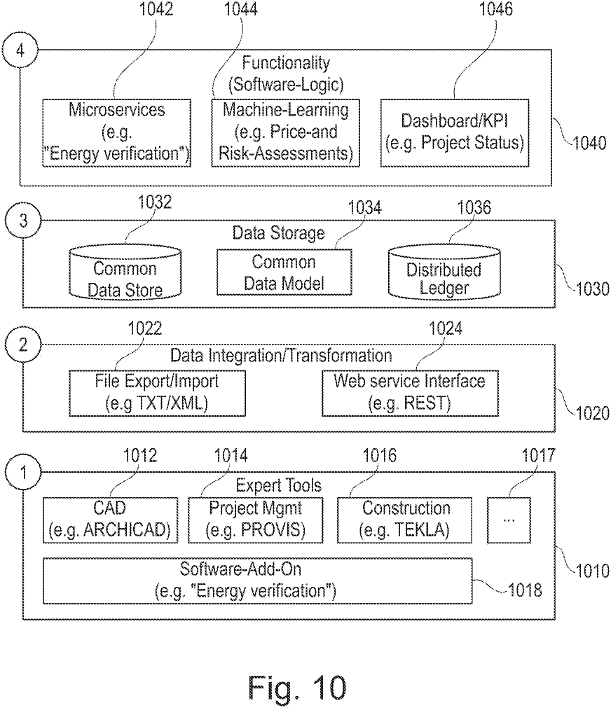

FIG. 10 A further embodiment of the system and the method of operating it; and

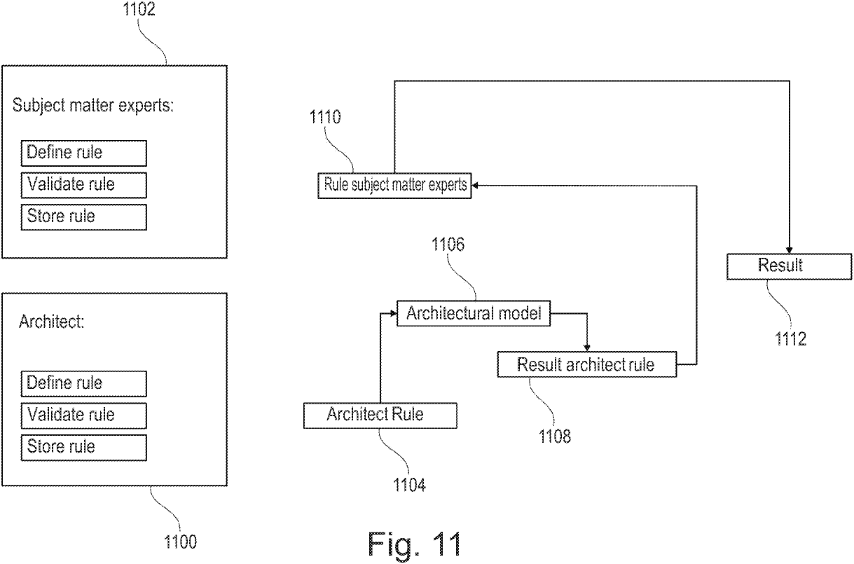

FIG. 11 A further embodiment of the system and the method for its operation;

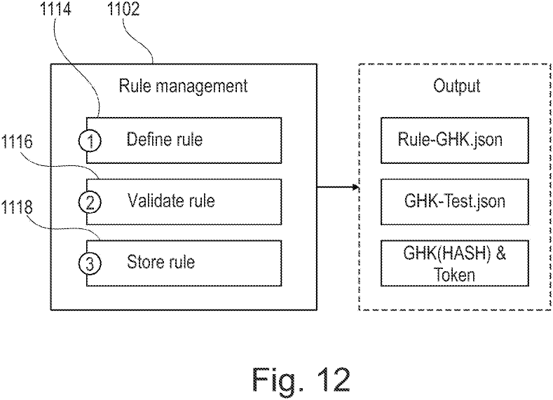

FIG. 12 A further embodiment of the system and the method of operating it; and

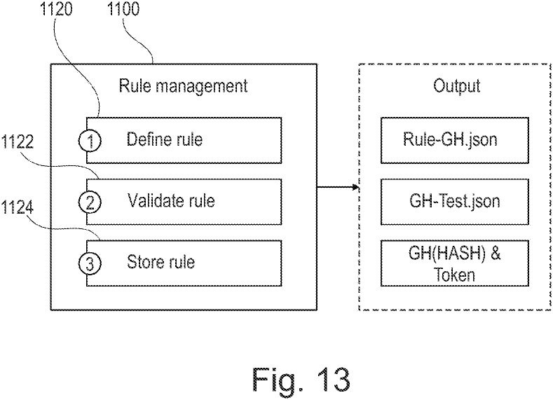

FIG. 13 A further embodiment of the system and the method for its operation.

With reference to FIG. 1, a first embodiment of the system is described.

The system 200 includes an input module 210, an output module 212, and a server module 214.

It further comprises, in the embodiment example, a calculation module 216.

It further comprises, in the embodiment example, an authentication module 218.

It further comprises, in the embodiment example, an interface 220.

It further comprises, in the embodiment example, an energy detection generation module 222.

It further comprises, in the embodiment example, a power consumption module 224.

It further comprises, in the embodiment example, a design module 226.

It further comprises, in the embodiment example, a plausibility module 228.

In the example embodiment, the modules 210 to 228 are implemented as software modules executed by a computing unit.

In further embodiments, the modules 210 to 228 may be executed at least in part by other computing units. In particular, individual modules 210 to 228 can be accessed in the manner of a cloud application, with execution of the corresponding software module taking place at a server to which the system 200 has a data link.

In the example embodiment, a central storage unit (not shown) of the system 200 is provided for access by all modules 210 to 228, but rights management is provided to allow selective read and/or write access to individual files.

In the example embodiment, an approval authority 300 is further provided, which is formed here by an external server 300. There is a data link between the system 200 and the approval authority 300 at least from time to time.

In the example embodiment, the data connection is established via the Internet. However, in further embodiments, it may be established by other means, such as by means of another local area network (LAN) or wide area network (WAN) of computers, by means of a telephone network or a mobile network, or by other means.

With reference to FIG. 1, a first embodiment of the method for operating the system is described. This is based on the embodiment example of the system described above with reference to FIG. 1.

In the example embodiment, a user interface is provided by the input module 210 and the output module 212.

In this regard, the input module 210 allows data concerning a building and/or components of the building to be entered.

The output module 212 allows output of data concerning the building and/or components of the building, wherein output data is generated and output by means of a display device, such as on a monitor.

The server unit 214 holds data concerning the building and/or components of the building.

The calculation module 216 is arranged to automatically calculate planning and/or approval data of the building. This is done on the basis of data concerning the building and/or the components of the building.

In the example embodiment, the planning and/or approval data may be or may include energy certification data of the building. The user can make the corresponding settings.

The authentication module 218 is set up to provide the planning and/or approval data in a completely traceable and tamper-proof manner.

For this purpose, the example embodiment uses a DLT method, in particular a blockchain method, by means of which the generation and modification of the data provided is cryptographically documented. In further embodiment examples, other methods can be used alternatively or additionally, whereby in particular various DLT methods can be used.

The interface 220 of the system 200 is used to establish a data link to the licensing authority 300, with the interface 220 being such that it enables secure exchange of data relating to the building and/or components of the building. In the example embodiment, cryptographic methods are used to prevent unauthorized reading of the transmitted data and to sign the transmitted data so that unauthorized changes are prevented.

The energy certificate generation module 222 is configured to automatically generate an energy certificate for the building based on data calculated and/or provided by the calculation module 216.

The energy consumption calculation module 224 is adapted to calculate the energy consumption of the building, in particular including data concerning the building and/or components of the building.

The construction module 226 is used to construct the building and/or its components. In another embodiment, the construction module 226 is not included by the system 200, but is implemented on an external computing device and the system 200 is connectable to the construction module 226.

The plausibility module 228 is arranged to check the data calculated by the calculation module 214 for plausibility based on plausibility data stored in the plausibility module 228.

In the example embodiment, the plausibility module 228 is self-learning.

With reference to FIG. 2, a further example embodiment of the method for operating the system is explained. This is based on an example embodiment of the system 200 which is designed analogously to the system 100 explained above with reference to FIG. 1. The reference signs used in FIG. 1 are also used here to refer to analogously designed modules and elements.

This example embodiment describes the process in a rather generic manner. Steps 10 to 50 shown in the first line of the diagram denote stages of the process flow, while steps 110 to 150 shown below denote individual sub-sections of the process.

The system 100 is indicated by a dashed line to show which steps are executed in the system 100 in a narrower sense. In particular, the steps 110 to 150 shown in the area of the system 100 are performed at least partially in an automated manner.

In the example embodiment, all steps are performed electronically. In particular, a user interface is provided to a user, by means of which inputs can be recorded and/or the sequence of the process can be controlled.

In particular, the example embodiment implements a “Digital Building System” (DBS).

In a first step 10 “Create use case & load data” of the procedure, a use case is created and the relevant data is loaded.

In a step 11 “Opens DBS interface” a user interface is opened.

In a step 12 “Selects project” a project is selected.

In a step 13 “Selects use case” a use case is selected.

In a step 14 “Loads documents into DBS” documents are loaded.

In a step 110 “Imports documents into database (interfaces)”, the system imports documents into a database. Interfaces are provided for this in particular, for example to the database and to an input device.

In a step 111 “Structured data (ETL)” the available data, in particular data concerning the building and/or components of the building, are structured, whereby in particular a procedure of the structure “Extract, Transform, Load” (ETL) is carried out, as already explained above.

In a step 112 “Assigns data to use case (APS Matching)”, the relevant data is assigned to the use case, in particular by means of a procedure for “APS Matching”, as already explained above.

In a step 113 “Prepares data for check (APS Matching)”, the data is prepared for a check, whereby the “APS Matching” as described above is also performed.

In a second stage 20 “Examine data and release for analysis”, the available data are examined and released for analysis.

In a step 21 “Examines prepared data for correctness” the data prepared in the first step 10 are examined for correctness.

In a step 22 “Modifies and supplements data”, the data is modified and/or supplemented if necessary.

In an optional step 23 “Updates documents (optional)” existing data and documents are updated.

In a step 24 “Releases data for analysis” the data is released for analysis.

In a step 120 “Analyzes data and searches for patterns (pattern recognition)”, the data is analyzed using a pattern recognition procedure and patterns are searched for.

In a step 121 “Evaluates patterns and develops recommendations (recommendations)”, the identified patterns are evaluated and recommendations are generated and issued.

In a step 122 “Supplements data & algorithm (database)” the data is supplemented and an algorithm is used, by means of which a suitable data store is provided as a database for the historicized storage of all data required for the AI services.

In a further stage 30 “Study analysis and release to experts” the analysis is studied and released to an expert.

In this context, an “expert” or “subject matter expert” is in particular a qualified person, such as a civil engineer or architect, who is authorized to make certain changes to the data and/or to generate certain data and/or to issue a permit, certificate or similar document. The expert may further be an authorized organization, entity, or agency. In the example embodiment, an authentication step is provided in which a user must prove his or her authentication, such as in a login process.

In a step 31 “Examines result of analysis” the result of the previously performed analysis is examined.

In a step 32 “Modifies and supplements data”, the data is modified and/or supplemented if necessary.

In an optional step 33 “Updates documents (optional)” existing data and documents are updated.

In a step 34 “Releases data for experts” the data is then released for an expert.

In a step 130 “Prepares data for subject matter expert (APS Matching)”, the data now available is prepared for a subject matter expert, again using “APS Matching” as described above.

In a step 131 “Creates Request (ETL)”, a request is created using an ETL procedure as explained above.

In a further stage 40 “Examine evidence and generate feedback”, the evidence is examined and feedback is generated and issued.

In a step 41 “ Reviews application ” the previously created application is reviewed.

In a step 42 “Validates analysis results” the analysis results are validated.

In step 43 “Documents feedback”, feedback is generated and documented.

In a step 44 “Confirms the test result” the test result is confirmed.

In a step 140 “Supplements data of the subject matter expert (ETL, APS Matching)”, the data provided and/or supplemented by the subject matter expert are supplemented, using in particular procedures of ETL and/or “APS Matching”, as already described above.

In a step 141 “Creates test result (ETL, APS Matching)”, the test result is documented and can in particular be created and output, whereby ETL and/or “APS Matching” procedures are also used here in particular, as already described above.

In a further stage 50 “Filing of official documents”, filing of the official documents takes place, whereby in particular secure filing takes place, whereby changes to files cannot be made without authorization and/or whereby changes are always documented.

In a step 51 “Selects official documents” official documents are selected.

In a step 52 “Loads official documents” the selected official documents are loaded.

In a step 150 “Stores official documents (unchangeable filing)”, the official documents are stored using the procedures of an unchangeable filing described above.

In the following, FIG. 3 is used to describe a further example embodiment of the method for operating the system. This further example embodiment describes the method described above with reference to FIG. 2 more concretely for the example of creating an energy certificate for a building. This example embodiment is a more concrete variant of the example embodiment of the method already described above with reference to FIG. 2. For this reason, the same reference signs are used for individual stages and steps.

In a first step 10 “Create use case & load data” of the procedure, a use case is created and the relevant data is loaded.

In a step 11 “Opens DBS interface” a user interface is opened.

In a step 12 “Selects project” a project is selected.

In a step 13 “Selects energy verification” a use case is selected. In this case, the use case is an energy verification.

In a step 14 “Loads 3D plan (Archicad file) into DBS” documents are loaded. Specifically, the documents here include a 3D plan of a building or part of a building.

In a step 110 “Imports 3D plan into database (interfaces)”, the system imports the loaded documents, in particular the 3D plan, into a database. Interfaces are provided for this purpose, for example to the database and to an input device. In this example embodiment, for example, an interface to a design module is used in which the 3D plan was created.

In a step 111 “ Structures data (ETL)” the available data, in particular data concerning the building and/or components of the building, are structured, whereby in particular a procedure of the structure “Extract, Transform, Load” (ETL) is carried out, as already described above.

In a step 112 “Assigns data to energy certificate (APS Matching)”, the relevant data is assigned to the energy certificate use case, in particular by means of a procedure for “APS Matching”, as described above.

In a step 113 “Prepares data for check (APS Matching)”, the data is prepared for a check, whereby the “APS Matching” described above is also performed.

In a second stage 20 “Examine data and release for analysis”, the available data are examined and released for analysis.

In a step 21 “Reviews project data and data of the elements of the 3D plan” the project data and data of the elements of the 3D plan prepared in the first step 10 are reviewed.

In a step 22 “Modifies and supplements data”, the data is modified and/or supplemented if necessary.

In an optional step 23 “Updates documents (optional)”, existing data and documents are updated, i.e. in particular the data of the 3D plan.

In a step 24 “Releases data for analysis (energy verification)” the data is released for an analysis, whereby the analysis is to be carried out with regard to the energy verification.

In a step 120 “Analyzes data and searches for patterns (pattern recognition)”, the data is analyzed using a pattern recognition procedure and patterns are searched for.

In a step 121 “Evaluates patterns and develops recommendations (recommendations)”, the identified patterns are evaluated and recommendations are generated and issued.

In a step 122 “Supplements data and algorithm (database)” the data is supplemented and an algorithm is used, by means of which a suitable data store is provided as a database for the historicized storage of all data required for the AI services.

In a further stage 30 “Study analysis and release to experts” the analysis is studied and released to an expert.

In particular, an expert is a qualified person, such as a civil engineer or architect, who is authorized to make certain changes to the data. In the example embodiment, an authentication step is provided in which a user must prove his authentication, for example during a login process.

In a step 31 “Checks result of analysis (energy verification)” the result of the previously performed analysis is reviewed with regard to the energy verification.

In a step 32 “Modifies and supplements data”, the data is modified and/or supplemented if necessary.

In an optional step 33 “Updates documents (optional)”, existing data and documents are updated, in particular the data of the 3D plan.

In a step 34 “Releases data for experts” the data is then released for an expert.

In step 130 “Prepares data for energy expert (APS Matching)”, the data now available is prepared for a subject matter expert, again using “APS Matching” as described above. The subject matter expert is authorized in particular to perform checks in the area of energy and energy verification.

In a step 131 “Creates Request (ETL)”, a request is created using an ETL process as described above.

In another stage 40 “Review evidence and generate feedback” evidence is reviewed and feedback is generated and issued.

In a step 41 “Reviews application for energy certificate” the previously created application for an energy certificate is reviewed.

In a step 42 “Validates analysis results” the analysis results are validated.

In step 43 “Documents feedback”, feedback is generated and documented.

In a step 44 “Confirms the test result” the test result is confirmed.

In a step 140 “Supplemented data of the subject matter expert (ETL, APS Matching)”, the data provided and/or supplemented by the subject matter expert is supplemented, using in particular procedures of ETL and/or “APS Matching”, as already described above.

In a step 141 “Creates test result (ETL, APS Matching)”, the test result is documented and can be created and output, whereby ETL and/or “APS Matching” procedures are also used here in particular, as already described above.

In a further stage 50 “Filing of official documents”, filing of official documents takes place, whereby in particular secure filing takes place, whereby changes to files cannot be made without authorization and/or whereby changes are always documented.

In a step 51 “Selects official documents” official documents are selected.

In a step 52 “Loads official documents” the selected official documents are loaded.

In a step 150 “Stores official documents (immutable filing)”, the official documents are stored using the procedures of an immutable filing described above.

In further examples embodiments, an analysis may be performed with respect to other aspects of the planning and/or permitting process, such as fire safety.

With reference to FIG. 4, a further example embodiment of the system and method for its operation is described. The structure of this further example embodiment is essentially similar to that already described above. It is therefore not necessary to describe all analogously designed elements again in detail.

The system and the method for its operation can be used for a variety of different purposes in this further example embodiment. In particular, an architect is envisaged as a user, who is in charge of the design of the building or part of the building and who organizes the obtaining of various permits and verifications. On the other hand, subject matter experts are envisioned, either as users or as external entities accessible via interfaces of the system.

The system can be used to apply for an energy certificate.

It can be used to apply for a permit regarding fire safety regulations.

It can be used to apply for a permit concerning regulations on sound insulation.

Accordingly, a subject matter expert may be provided who is qualified for the particular use of the system, such as a subject matter expert in the area of energy verification, fire protection, and/or noise control.

In a first step 410 “create flow” a project is started. Documents are uploaded.

Structured data is generated by the system based on the uploaded data.

The uploaded data includes in particular documents.

For example, the documents may include 3D and/or 2D design data and/or they may include other documents.

In particular, the structured data is stored.

In a further step 420 “Review data” a review of the available data takes place.

The system detects patterns in this step 420. For example, an outer wall and/or an escape route is detected.

Data about the recognized patterns are stored in particular.

In a further step 430 “flow analysis”, various checks are made on the data and the data are analyzed.

For example, a suitability and/or acceptability of a material is checked, a clearance value is checked, and/or a cable is checked.

For example, the system performs the analysis based on empirical values and assigns a value to various test parameters, such as “yes”, “no” or “maybe”.

In a further step 440 “Feedback Experts” a check and feedback takes place.

In particular, this step is performed at least in part by a subject matter expert who is qualified according to the application.

In particular, the system generates new experience values based on the feedback, which can be used for analysis, for example, during further use of the system in step 430. When generating new experience values, a method from the field of artificial intelligence (AI) can be used in particular.

In another step 450 “Verification” official documentation is generated.

In particular, the system performs storage in a safe. Secure digital storage can be achieved, for example, by means of a cryptographic or blockchain process. Alternatively or additionally, other methods can be used, for example from the field of distributed ledger technology.

It is also conceivable, for example, to use a private DLT process in order not to have to make certain information accessible. In addition, this can save costs for third parties, e.g. for mining.

In principle, it is also conceivable to resort to and use a public DLT method.

It is also possible that both private DLT methods and public DLT methods are used.

The system has a plurality of modules 460, 470, 480 that are used to, among other things, perform the method of operating the system.

A module 460 “Translation” includes in particular a unit described as “the Translator - Common Data Environment”. This module 460 ensures compatibility of different data formats with the system. For example, it may be oriented to convert a particular data format to a particular other data format.

Various protocols, standards, and/or methods encompassed by translation module 460 include IFC, CAD, XML, BIM, CoBIE.

The translation module 460 is designed to ensure openness and individual usability of the system.

In particular, a “pattern recognition” module 470 comprises a unit described as “the Brain - Machine Learning Algorithm”. This module 470 is arranged to execute a machine learning procedure based on 2D, 3D and/or other documents. For example, a neural network and/or other method may be used.

In particular, the pattern recognition module 470 is used for pattern recognition based on the uploaded data in step 420.

In particular, the pattern recognition module 470 may be configured to perform the machine learning process iteratively.

In particular, an “official documents” module 480 comprises an entity described as “the Safe - Distributed Ledger”. This module 480 is set up to document and/or store final plans, recommendations and/or certificates in a secure and trustworthy manner.

In this regard, module 480 is particularly configured to ensure security and trustworthiness by means of a blockchain procedure. In further embodiments, other processes can also be used, for example from the field of DLT processes.

With reference to FIG. 5, an example embodiment of pattern recognition performed by means of the system is described.

In this example embodiment, the structure of a portion of a wall is detected.

In the example of pattern recognition analysis shown here, sketches and/or design data are reviewed for known elements, modules, or products of the APS. Text data is reviewed for known information. A pattern recognition result is formed and the result is assigned to the structured data. For example, the analysis is performed using structured data from CAD software.

In the example, the result of the pattern recognition includes information about a wall module type “timber construction medium”, about used materials, such as a formwork vertical, battens horizontal, wind paper full-surface, gypsum fiberboard, studs, gypsum fiberboard, LDS, gypsum board as well as spackling. Furthermore, a concrete outer edge is detected.

The detected elements 501 to 510 are identified in FIG. 5 as the following elements:
a formwork 501 of the type “Formwork vertical N+K, 26 mm, spruce/fir rough sawn, raised, visibly screwed, final coating 2x Impralan D400 Outback”,
a batten 502 of the type “batten horizontal 30-55/50, 30-55 mm”,
Wind paper 503 full surface,
Gypsum fiberboard 504 15 mm,
Stud 505 of the type “Stud C24 60-100/280 (according to statics), a=625 mm, insulation MF (RF1), >26 kg/kg/m3, >1000° C., <0.036 W/mK”,
Gypsum fiberboard 506 15 mm,
LDS 507 with a full-surface foil, Sd=20 m
Gypsum board 508 of the type “Type F (RF1), 15 mm”,
Filler 509 4 mm and
an electrical box 510, locally wrapped in vapor retarder.

With reference to FIG. 6, a further example embodiment of the system and the method for its operation is described. Various elements are analogous to those already described above and are therefore not described again in the same detail.

In the example embodiment, a DBS platform 610 is implemented that includes various levels or layers and modules, as further described below.

One level relates to users 612 of the DBS platform 610. In particular, internal users may be provided, such as architects, project planners, and the like. In particular, external users may be provided, such as suppliers, engineers, authorities, and the like.

Another level relates to a DBS portal 614.

In particular, the DBS portal 614 includes interfaces, such as a DBS “user interface private” 614a and/or a DBS “user interface public” 614b.

By means of the interfaces 614a, 614b, internal and/or external users in particular can access the DBS 610.

In the example, the DBS platform 610 further comprises an adaptable product system 616.

In the example, this comprises product specifications and instances 616a, in particular product specifications and instances with user-defined attributes, relationships and values.

It further comprises, in the example, a central repository 616b.

Further, in the example embodiment, DBS services 618 are provided.

In the example embodiment, these comprise use cases 618a, in particular defined use cases including roles, activities, business rules, and data requirements.

In the example, they further comprise DBS Use Cases 618b.

Further, in the example embodiment, a module for DBS integration 620 is provided.

In the example, this includes modules for file import/export 620a, for an API 620b (application programming interface) and for an ETL 620c (extract, transform, load).

Further, in the example embodiment, expert software tools 622 are provided, particularly comprising any software used by experts.

Furthermore, a “data warehouse” module 624, which in particular enables data from different sources to be combined in a way that is optimized for analysis.

In the example embodiment, a module for DBS AI services 626 is further provided, which in particular comprises DBS AI algorithms. In particular, various methods from the field of machine learning and artificial intelligence can be used.

In the example embodiment, a module for DBS DLT services 628 is further provided.

This includes in particular modules for “DBS Ledger private” and “DBS Ledger public”.

By means of this module 628, in particular, a method for documenting transactions using a distributed ledger technology method is implemented.

In particular, public and private distributed ledger techniques are provided, with public ones allowing participation and data viewing by multiple network participants, while private ones restrict this.

With reference to FIG. 7, a further example embodiment of the system and the method for its operation is described. Various elements are analogous to those already described above and are therefore not described again in the same detail.

The figure shows different levels that are assigned to different users or layers of users. This separates the tasks of different users.

In the example embodiment, users include a product manager 702, an architect/planner 704, and an expert 706.

The figure further illustrates various stages of the method. Furthermore, the structure of a digital building system (DBS) 780 for the example embodiment is shown and the accesses to different modules is assigned to the individual stages of the method.

In a first stage “product definition” 710 information of the use cases is stored in the APS Database.

In a step 712, the product manager defines 712 roles, activities, ground rules, and requirements for data.

Here, in a step 714, input to the use case is provided at the expert 706 level.

In this stage 710 data is transferred to an APS Database 781 and a DBS DWH 782 is used as a data warehouse module.

At another level “Plan creation” 720 information of the use cases are contained in the elements, for example insulation values.

In a step 722, a plan is created as a draft at the architect/planner 704 level based on the APS Database.

At this level 720 data is provided by the APS Database 783.

In another stage “plan review” 730 plans are synchronized across all disciplines and reviewed with the experts.

At the transition from the plan generation step 722 to a step 732, a “quality gate” 760 is provided, abbreviated as “QG1”. Here plans are reviewed based on DBS AI algorithm and documents are written to DBS Ledger.

With a “quality gate” 760 as a step, DBS AI algorithms 784 are used to utilize an artificial intelligence or machine learning method. Furthermore, a module is used as a DBS ledger 785.

This means that in this example, the plans are checked using an artificial intelligence or machine learning process. Furthermore, the documents are securely documented using a distributed ledger process.

In step 732 (at the architect/planner 704 user level), the reviewed and documented draft plan is sent to experts for review.

In a subsequent step 734 at the expert 706 level, the draft plan is reviewed and input is documented.

At this level 730, DBS Services 786 is accessed as a module of DBS 780.

In a “Plan Release” 740 stage, plans are again synchronized across all disciplines and released with the experts.

At a transition from step 734 to a step 742, a “quality gate” is again provided.

In the “Quality Gate”, DBS AI Algorithm 787 is used to utilize an artificial intelligence or machine learning method. Furthermore, a module is used as DBS Ledger 788.

Step 742 is provided at the level where the architect/planner 704 acts as the user. In this step 742, the draft plan is modified and sent to experts for approval.

Then, in a step 744, the draft plan is reviewed at the expert 706 level as the user and approval is documented as appropriate.

In a stage “execution testing” 750 the execution of the construction is synchronized across all disciplines and approved with the experts.

At this level 740 DBS Services 789 are used.

Starting from the step 744 described above, a “quality gate” is performed and, in a step 754, an execution is documented at the level of the architect/planner 704 as the user and sent to an expert for approval.

With a “quality gate” as a step, DBS AI algorithm 790 is used to utilize an artificial intelligence or machine learning method. Furthermore, a module is used as DBS Ledger 791.

In a step 756, at the level of the expert 706 as user, the execution is reviewed and a release is documented.

At the 750 level, DBS Services 792 are used.

The transition to another step 752 at the level of the product manager 702 as the user is made via another “quality gate” as a step. In step 752, the APS database is updated with product information.

In the “Quality Gate” as a step, DBS AI algorithm 793 is used to utilize an artificial intelligence or machine learning method. Furthermore, a module is used as DBS Ledger 794.

With reference to FIG. 8, a further example embodiment of the system and the method for its operation is described. Various elements are analogous to those already described above and are therefore not described again in the same detail.

Two different processes are shown, with the conventional route of the planning and approval process shown at the top and the execution using the system shown at the bottom. Various steps of the procedure are automated by the system, which is shown by dashed outlines. In the example, an energy certificate is to be created for a planned building or part of a building.

First, the upper case of the non-automated process is described.

Three user levels are distinguished. In the example, the different users are an architect 802, a civil engineer 804 and a public authority 806.

The arrangement of steps 808 to 822 indicates at which user level the steps are performed.

In a step 808, a 3D plan is created at the level of the architect 802 as the user.

Based on the data of the 3D plan, a list and values are generated in a further step 810 at the level of the civil engineer 804.

In a step 812 at the same level of the user 804, an energy verification is calculated.

In a further step 814, a result is created and feedback is generated.

In a further step 816 - now again at the user level of the architect 802 - the 3D plan is modified and in an iterative process the procedure returns to step 810.

If necessary, i.e. if no changes to the 3D plan are required or if no recalculation of the energy certificate needs to be performed, the 3D plan is finalized in a step 818.

At the level of the civil engineer 804 as the user, the calculations are finalized in a step 820.

In a further step 822, the energy certificate is then prepared at the authority 806 level.

In the following, the lower case of the method is described, as it is executed using the system at least partially automated.

In this case, too, three user levels are distinguished. In the example, the different users are an architect 852, a civil engineer 854 and a public authority 856.

The arrangement of steps 858 to 872 indicates at which user level the steps are performed.

In a step 858 at the level of the architect 852 as user, data maintenance is performed for various modules, in particular by means of an APS.

In a further step 859, a 3D plan is created, as already explained above.

In a further step 860 - automated by the system, but on the level of the civil engineer 854 as user - a list and values are generated based on the 3D plan and in a step 862 the energy certificate is calculated.

In a step 864, a result is then produced and feedback is generated, and in the example, this is done by the civil engineer 854.

In a step 866, at the level of the architect 852 as the user, the 3D plan is updated.

To the extent that the changes require it, an iterative process is used to return to step 860.

If appropriate, the 3D plan is finalized in a step 868.

In a step 870, the calculations for the energy certificate are finalized. In the example, this is done automatically by the system, but at the level of the civil engineer 854.

In a further step 872 the authority 856 prepares the energy certificate.

With reference to FIG. 9, a further example embodiment of the system and the method for its operation is described. Various elements are analogous to those already described above and are therefore not described again in the same detail.

Different levels of the system are shown with different elements and modules used to execute the procedure.

A portal 910 is provided, which serves to form a user interface, for example, or which is formed by a user interface through which the system can be accessed or the system can be operated.

At another level, a module is provided for organizing use cases 920 that include, for example, energy verification 921, fire protection 922, sound insulation 923, and/or other use cases 924.

Furthermore, a module 925 is planned for the implementation of so-called business rules.

Furthermore, a module 926 is provided for the implementation of algorithms from the field of artificial intelligence or machine learning.

Furthermore, a module 927 is provided for the implementation of a so-called Common Data Environment.

Furthermore, a module 928 is planned for the implementation of a so-called data warehouse.

Furthermore, a module 929 is provided for implementing a so-called distributed ledger method.

An integration level 930 is provided as a further level.

Furthermore, a level 940 is provided for connection to expert software. In the example, modules for connection to Archicad 941, Provis 942, CAD-Works 944 or other expert software 943, 945 are provided here. In further example embodiments, modules for virtually any programs may be provided herein.

With reference to FIG. 10, a further example embodiment of the system and the method for its operation is described. Various elements are analogous to those already described above and are therefore not described again in the same detail.

Various levels of the system are shown with different elements and modules that are used to execute the process. In particular, core components of an example embodiment of the system are described.

In a level 1010 “Expert Tools” modules 1012 to 1018 are provided, which allow an integration of data of different software programs, which are used by different experts. These software programs usually run on separate computers. The Digital Building System (DBS) uses data from these programs.

In further examples embodiments, it is envisaged that the operation of these programs is influenced, for example by means of additional functionalities provided by means of SPAG as a so-called “software add-on”.

In the example embodiment, modules are provided for CAD 1012, such as ArchiCAD, for project management software 1014, such as Provis, for design software 1016, such as Tekla, and/or other programs 1017. Furthermore, a software add-on 1018 is provided, for example for an energy verification.

In a level 1020 “Data integration and transformation”, modules 1022, 1024 are provided, which concern the use of data from different sources. In the example, a module 1022 is provided for exporting and importing data, for example in the file formats TXT and XML, and a module 1024 is provided for an interface to web services, for example using REST.

In this level 1020, data integration can be carried out in particular by reading them in at least partially automatically by the programs provided in the “Expert Tools” level 1010. A standardized file transfer is provided for this purpose.

In a “data storage” level 1030, modules 1032, 1034, 1036 are provided by means of which secure documentation and/or storage of data and documents can be performed.

In the example, a module 1032 “Common Storage” is provided for a general storage of data.

Furthermore, the example provides a module 1034 “Common Data Model” for a general modeling of the data.

Further, the example provides for a module 1036 “Distributed Ledger” that allows the use of a documentation of transactions using distributed ledger technology.

For example, data is stored either in the general memory 1032, such as price information, or by means of a distributed ledger 1036, such as data relating to an energy audit. The storage location depends in particular on whether the storage is for external parties and must be secured accordingly. Both forms of storage are based on a common data model, which is formed in particular in such a way that internal and external partners can access the relevant and accessible data.

In a level 1040 “Functionality (Software-Logic)” modules 1042, 1044, 1046 are provided, which realize various software solutions of the system.

In particular, at this level 1040, the core functionalities of the system are provided by so-called microservices 1042 that are executable independently of each other. For example, microservices 1042 may relate to an energy detection system.

A module 1044 may provide algorithms from the field of artificial intelligence or machine learning, such as for evaluating prices and risks.

A 1046 module can serve as a so-called “dashboard” or KPI, for example to manage a project status. This can be used to access so-called “Key Performance Indicators”.

Referring to FIG. 11, another embodiment example of the system and method for its operation is described.

The System 200 can also enable an automated check of legal regulations as part of the approval of a building. In this respect, the architect and the technical expert can define, validate and store rules in their own rule administrations 1100, 1102 through the DBS.

These rules can then be used for a construction project as follows:

The architect applies a validated rule 1104 to extract information from an architectural model 1106 and the corresponding result 1108 then represents the input variable for review by the subject matter expert.

The subject matter expert uses his own validated rule 1110 to check a legal requirement and applies it to the result 1108 of the architect’s rule. The architect’s result 1108 includes validation of the correctness of the architect’s information, thus no rechecking by the subject matter expert is required and further calculation following the result 1112 can be automated.

Thus, the result and the data used in the approval process are traceable and stored unchangeably for all parties involved.

With reference to FIG. 12, an example embodiment of the underlying rule management system 1102 shown in FIG. 11 is described, with a closer look at the definition, validation, and storage of a rule of a fire protection expert as a subject matter expert.

First, the rules are created and stored in a definition step 1114 by the user, in this case a fire protection expert, in a defined syntax, including defined variables.

Swiss fire protection regulations, for example, vary depending on the height of the building. So-called building height categories are defined for this purpose:
Buildings of low height: up to 11 m total height;
Medium height buildings: up to 30 m total height;
High-rise buildings: more than 30 m total height;
   From this legal requirement, the user can define the following rule:
      VARIABLE TOTAL HEIGHT
      VARIABLE BUILDING HEIGHT CATEGORY
      whereby apply
      IF TOTAL HEIGHT <= 11 m THEN BUILDING HEIGHT CATEGORY=“low” ELSE
      IF TOTAL HEIGHT <= 30 m THEN BUILDING HEIGHT CATEGORY=“medium” ELSE
      BUILDING HEIGHT CATEGORY=“high”
   The rules created are then validated by the fire protection expert in a validation step 1116, for which test data with input data and expected result are defined. For the validation applies:
      TEST 1 SET TOTAL HEIGHT=“10” AND SET BUILDING HEIGHT CATEGORY =“low”
      TEST 2 SET TOTAL HEIGHT=“15” AND SET BUILDING HEIGHT CATEGORY =“medium”
      TEST 3 SET TOTAL HEIGHT=“32” AND SET BUILDING HEIGHT CATEGORY =“high”
   Finally, the validated rule, the test data and the results of the test are stored in a storage step 1118 (e.g. in JSON format).

The system can then calculate the HASH (e.g. CRC, MD5, SHA1, SHA256) of the rule file and the user confirms the rule with a personal token (e.g. ERC-20).

With reference to FIG. 13, an example embodiment of the underlying rule management 1100 of a rule of an architect in FIG. 11 is described.

The user, in this case the architect, also creates and saves a rule in a defined syntax, including defined variables in a definition step 1120; the following is an example of the building height.

According to legal regulations, the building height is the distance between the highest point of the roof structure, without technical superstructures, and the lowest point on the authoritative terrain.

Based on this legal requirement, the architect can define the following rule:
VARIABLE ROOF MAX
VARIABLE TERRAIN-MIN
VARIABLE Z-VALUE-MAX
VARIABLE Z-VALUE REFERENCE
VARIABLE TERRAIN-MIN
VARIABLE Z-VALUE-MIN
VARIABLE BUILDING HEIGHT
whereby applies
ROOF-MAX = Z-VALUE-MAX (ROOF)
REFERENCE = Z-VALUE REFERENCE (ELEVATION)
TERRAIN-MIN = Z-VALUE-MIN (ridge line)
BUILDING HEIGHT = (Z-VALUE-MAX - Z-VALUE-MIN) - REFERENCE

The rule for calculating the building height in accordance with regulations is also validated in a validation step 1122, for which the architect defines test data with input data and expected result and thus validates the rule.

For the validation of the rules using the example of fire protection applies:

TEST 1 SET ROOF_MAX=“10” AND SET REFERENCE =“505” AND TERRAIN-MIN=“ ” ...

In a storage step 1124 the rule, the test data and the results of the validation test are stored (e.g. in JSON format). The system calculates the HASH (e.g. CRC, MD5, SHA1, SHA256) of the rule file. Finally, the architect validates the rule with a personal token (e.g., ERC-20), which ensures that the rule is stored in a traceable and immutable manner.

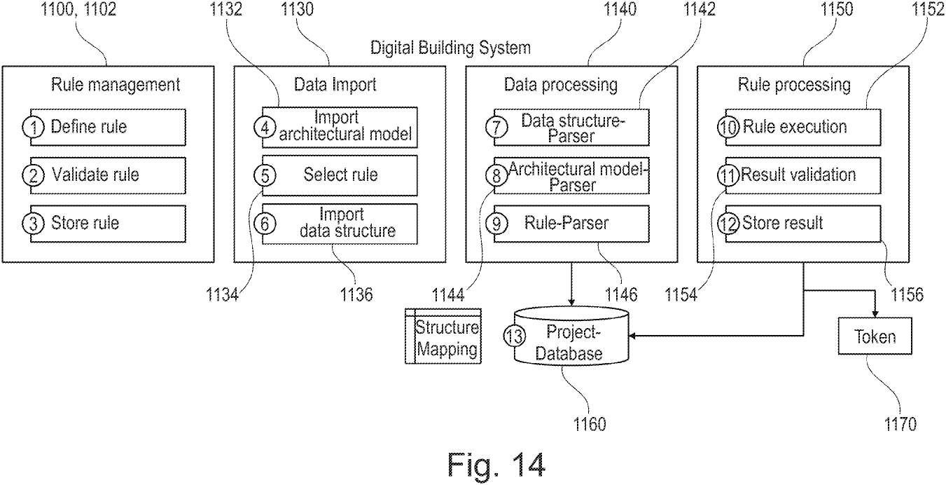

In FIG. 14, the processes or steps of the automated check of legal requirements in the DBS are illustrated, and in particular the steps that follow the rule management 1100, 1102 described in connection with FIG. 12 and FIG. 13 are described below.

The definition, validation and storage of the respective rules in the rule management 1100, 1102 of the subject matter expert and the architect is followed by the data import 1130 with the following steps:

Import of architectural model 1132; here the architect creates an architectural model in a CAD system (e.g. ArchiCAD), exports the model to a standard file format (e.g. ifc, csv, xml) and loads the file into the DBS;

Selection of Rule 1134:

The subject matter expert creates a rule, as shown in FIG. 12, in defined syntax and including defined keywords that formalize a legal requirement; and

The architect creates a rule, as shown in FIG. 13, in defined syntax and including defined keywords that formalize a legal requirement.

Import of data structure 1136; the architect imports a file that describes the data structure of the architecture model from step 1132. In this file, the objects and attributes of the architecture model are described in defined syntax.

For example, the following three parsers are then executed in the data processing 1140 flow:
Data structure parser 1142: From the loaded files (rules, data structure architecture model), the syntax used is linked to a standardized glossary for objects and attributes;
Architecture model parser 1144: The information from the loaded architecture model file is processed and loaded into the project database 1160; and
Rule parser 1146: The information from the selected rules is linked with the syntax from the data structure parser 1142.

Finally, the rules are processed in rule processing 1150, which involves the following steps:
Rule execution 1152: The selected rules from step 1134 are applied to the architectural model from the architectural model parser 1144 using the standardized data structures from the data structure parser 1142;
Result validation 1154: The result of the architect’s rule is validated by the architect. The validation is performed by confirmation of the architect with a token. The result validation contains a unique mapping to the rule used, the architectural model used, and the syntax used. The result of the rule of the domain expert contains the unique token of its rule; and
Result storage 1156: The result of the applied rules and all data used for them is stored. The individual files and the result of the work steps are stored as token 1170 (hash function).

Reference Signs

| | |
|---|---|
| 100 | System |
| 10 to 52, 110 to 150 | Step |
| 200 | System |
| 210 | Input module |
| 212 | Output module |
| 214 | Server module |
| 216 | Calculation module |
| 218 | Authentication module |
| 220 | Interface |
| 222 | Energy verification generation module |
| 224 | Energy consumption module |
| 226 | Construction module |
| 228 | Plausibility module |
| 300 | Approval authority; external server |
| 410 | Step |
| 420 | Step |
| 430 | Step |
| 440 | Step |
| 450 | Step |
| 460 | Module |
| 470 | Module |
| 480 | Module |
| 501 | Element |
| 502 | Element |
| 503 | Element |
| 504 | Element |
| 505 | Element |
| 506 | Element |
| 507 | Element |
| 508 | Element |
| 509 | Element |
| 510 | Element |
| 610 | DBS Platform |
| 612 | User |
| 614 | DBS Portal |
| 614 a | DBS User Interface private |
| 614 b | DBS User Interface public |
| 616 | Adaptable Product System |
| 616 a | Product specifications and instances |
| 616 b | Central repository |
| 618 | DBS Services |
| 618 a | Application cases |
| 618 b | DBS Use Cases |
| 620 | DBS Integration |
| 620 a | File Import/Export |
| 620 b | API |
| 620 c | ETL |
| 622 | Expert Software Tools |
| 624 | Data Warehouse |
| 626 | DBS AI Services |
| 628 | DBS DLT Services |
| 702 | Product manager |
| 704 | Architect / Planner |
| 706 | Experts |
| 710 | Product definition |
| 712 | Step |
| 714 | Step |
| 720 | Plan preparation |
| 722 | Step |
| 720 | Plan preparation |
| 732 | Step |
| 734 | Step |
| 740 | Plan release |
| 742 | Step |
| 744 | Step |
| 750 | Execution test |
| 752 | Step |
| 754 | Step |
| 756 | Step |
| 760 | Quality Gate |
| 780 | Digital Building System (DBS) |
| 781 | APS Database |
| 782 | DBS DWH |
| 783 | APS Database |
| 784 | DBS AI Algorithms |
| 785 | DBS Ledger |
| 786 | DBS Services |
| 787 | DBS AI Algorithms |
| 788 | DBS Ledger |
| 789 | DBS Services |
| 790 | DBS AI Algorithms |
| 791 | DBS Ledger |
| 792 | DBS Services |
| 793 | DBS AI Algorithms |
| 794 | DBS Ledger |
| 802 | Architect |
| 804 | Civil engineer |
| 806 | Authority |
| 808 | Step |
| 810 | Step |
| 812 | Step |
| 814 | Step |
| 816 | Step |
| 818 | Step |
| 820 | Step |
| 822 | Step |
| 910 | Portal |
| 920 | Use cases |
| 921 | Energy certificate |
| 922 | Fire protection |
| 923 | Sound insulation |
| 924 | further use case |
| 925 | Business Rules |
| 926 | Algorithms (AI) |
| 927 | Common Data Environment |
| 928 | Data Warehouse |
| 929 | Distributed Ledger |
| 930 | Integration |
| 940 | Expert software |
| 941 | Archicad |
| 942 | Provis |
| 943 | further expert software |
| 944 | CAD Works |
| 945 | further expert software |
| 1010 | Expert Tools |
| 1012 | Module |
| 1014 | Module |
| 1016 | Module |
| 1017 | Module |
| 1018 | Module |
| 1020 | Data integration and transformation |
| 1022 | Module |
| 1024 | Module |
| 1030 | Data storage |
| 1032 | Module |
| 1034 | Module |
| 1036 | Module |
| 1040 | Functionality |
| 1042 | Module |
| 1044 | Module |
| 1046 | Module |
| 1100 | Rules management architect |
| 1102 | Rules management subject matter expert |
| 1104 | Rule architect |
| 1106 | Architectural model |
| 1108 | Result |
| 1110 | Rule subject matter expert |
| 1112 | Result |
| 1114 | Definition step |
| 1116 | Validation step |
| 1118 | Storage step |
| 1120 | Definition step |
| 1122 | Validation step |
| 1124 | Storage step |
| 1130 | Data import |
| 1132 | Architecture model import |
| 1134 | Rule selection |
| 1136 | Data structure import |
| 1140 | Data processing |
| 1142 | Data structure parser |
| 1144 | Architecture model parser |
| 1146 | Rule parser |
| 1150 | Rule processing |
| 1152 | Rule execution |
| 1154 | Result validation |
| 1156 | Result storage |
| 1160 | Project database |
| 1170 | Token |

1. System for automated planning and/or approval of at least one building, comprising
at least one input module for inputting data concerning the building and/or components of the building,
at least one output module for outputting data concerning the building and/or components of the building,
a server unit, on which data concerning the building and/or the components of the building are kept,
a calculation module), which is such that by means of the calculation module planning and/or approval data of the building are automatically calculable on the basis of data concerning the building and/or the components of the building.

2. A system according to claim 1, wherein the planning and/or approval data is or comprises energy verification data of the building.

3. A system according to claim 1 wherein the system (has an authentication module by means of which the planning and/or approval data can be provided in a completely traceable and tamper-proof manner.

4. A system according to claim 1, wherein the system comprises an interface to a licensing authority, the interface being such as to enable secure exchange of data concerning the building and/or the components of the building.

5. A system according to claim 1, wherein the system comprises an energy certificate generation module adapted to automatically generate an energy certificate for the building based on the data calculated and/or provided by the calculation module.

6. A system according to claim 1, wherein the system comprises at least one energy consumption calculation module, by means of which the energy consumption of the building can be calculated, including the data concerning the building and/or components of the building.

7. Asystem according to claim 1, wherein the system comprises or is connectable to at least one construction module.

8. Asystem according to claim 1, wherein the system comprises at least one plausibility module which checks the data calculated on the part of the calculation module for plausibility on the basis of plausibility data stored in the plausibility module.

9. A system according to claim 8, wherein the plausibility module is self-learning.

10. A system according to claim 1, wherein the calculation module is arranged to perform a rule-based automated calculation of data for planning and/or approval of at least one building.

11. A system according to claim 10, wherein the rules are validated and unchangeably determinable.

12. A system according to claim 11, wherein the rules are definable according to regulations of the parties involved in the planning and/or approval of at least one building.

13. A method of operating the system according to claim 1 for automated and/or partially automated approval and/or partial approval of a building.

14. (canceled)
